(19) United States
(12) Patent Application Publication
(10) Pub. No.: US 2017/0172109 A1
(43) Pub. Date: Jun. 22, 2017

(54) PET TREAT WITH PERFORATED RAWHIDE AND SELECTED FILLER

(71) Applicant: The KONG Company, LLC, Golden, CO (US)

(72) Inventor: Chuck Costello, Louisville, CO (US)

(21) Appl. No.: 14/971,698

(22) Filed: Dec. 16, 2015

(51) Int. Cl. A01K 15/02; A23K 10/26; A23K 50/40

(52) U.S. Cl. CPC A01K 15/026; A23K 50/40; A23K 10/26

(57) ABSTRACT

A pet treat is provided in the form of a chewable product made of animal hide and combined with one or more filler layers. The animal hide is optionally perforated. The filler layers may include one or more extruded pieces of consumable material, and/or one or more layers of a paste or viscous material capable of flowing into, or being pressurized or squeezed into the perforations.

### FIELD OF THE INVENTION

The invention relates to pet treats, and more particularly, to a pet treat that includes one or more perforated rawhide pieces and one or more selected fillers placed between the rawhide pieces.

### BACKGROUND OF THE INVENTION

Because of the increased commercialization of pet products to include pet toys and pet treats, there are now a wide range of commercially available products with very distinct functions and characteristics. For pet treats, there has been a significant expansion of the types of pet treats made available, to include pet treats made of a wide range of consumables and corresponding methods of manufacture.

Despite the increase in commercialization of pet products, one type of pet treat is still quite popular, namely, rawhide pet chew products. Rawhide is known to be a very durable consumable that can be impregnated with desired flavorings to further enhance attraction of the rawhide to an animal. Further, there are various methods of manufacturing rawhide chew products to include different ways in which flavoring can be added to the rawhide material.

Although rawhide is still a very popular material for use in chewable pet treats, there are certain drawbacks associated with use of rawhide. One drawback is the requirement to soften or otherwise treat the rawhide material so that it can be manipulated to be formed into a desired shape. Accordingly, additional manufacturing steps may be required to adequately treat rawhide material so that it can be used within a pet treat product.

While rawhide pet chew products may provide excellent mastication for animals as well as dental cleaning, there also are some potential risks associated with such chew products. One potential risk is digestive irritation in which some animals are sensitive or allergic to rawhide. Another potential risk is choking or digestive blockages in which an animal may ingest a large piece of rawhide.

One example of a prior art pet chew includes the invention disclosed in U.S. Pat. No. 6,840,196. This reference more particularly teaches a rawhide pet treat made by folding a first sheet of rawhide around a second sheet of rawhide. The second sheet of rawhide is flavored. An edge of the second sheet protrudes from under the first sheet to entice chewing and consumption of the pet treat by an animal. The first sheet of rawhide reduces opportunities for contact between the second sheet of rawhide and a decorative surface upon which the pet treat may rest.

Another example of a prior art pet chew product is the one disclosed in the U.S. Pat. No. 6,886,497 which is incorporated herein by reference in its entirety. The disclosed chew product is infused with chlorophyll or mint, or both, to freshen a dog's breath. The product may also be infused with sugar to increase palatability. An interior portion of the product can be perforated, such as by cutting, before the product is formed into a final shape. The perforations allow a dog's teeth to penetrate into the product and to be scraped clean by edges of the perforations.

Yet another example of a prior art pet chew product is disclosed in the U.S. Pat. No. 7,678,402 which is incorporated herein by reference in its entirety. This reference discloses a dog chew made of rawhide material with a large plurality of closely spaced perforations cut through the rawhide material during manufacture. The perforations are created in a number of first rows that are generally parallel to each other, and also in a number of second rows that are also generally parallel to each other. The first rows intersect the second rows to create a cross hatching pattern. The intersecting sets of perforations created by the cross hatching pattern define a large number of small sections on the rawhide. The small sections of the rawhide can individually break off when chewed by a dog instead of larger pieces that may potentially choke the dog.

Yet another example of a prior art pet chew is found in the U.S. Pat. No. 8,349,381. Preferred embodiments in this reference provide edible pet chews made with an outer casing of animal hide and one or more inner fillings manufactured through an extrusion process. A preferred filling may include a dry animal protein extrusion including percentages of animal protein, wheat gluten, mint, parsley, and dry vegetable materials.

Despite the number of pet chew products and related inventions in the prior art, there is still a need to provide a pet chew made of a hide material, such as rawhide, that overcomes some of the disadvantages associated with the prior art, yet provides a chew product that is still attractive to an animal, and can be manufactured within reasonable costs thereby making the chew product commercially viable.

### SUMMARY OF THE INVENTION

According to the invention, a pet treat is provided in the form of a chewable product made of animal hide and combined with one or more filler layers. At least a portion of the animal hide is perforated. The filler layers may include one or more extruded pieces of consumable material, and/or one or more layers of a paste or a viscous material capable of flowing into, or being pressurized or squeezed into the perforations.

According to preferred embodiments, the animal hide may include rawhide and the rawhide is perforated. The perforations may be uniformly sized and spaced from one another in a desired geometric pattern. One purpose of the perforations is to make the rawhide more workable, that is, easier to form or mold into a desired shape in which the perforations lessen the stiffness or density of the rawhide material. Another purpose of the perforations is to provide a pet chew in which an animal may more easily chew and separate a smaller piece of the treat, which may lessen potential occurrences of digestive discomfort and/or choking that are more common with ingestion of larger pieces of material. Yet another purpose of the perforations is to provide an irregular and variable surface in which a filler layer is able to attach and penetrate.

According to other preferred embodiments, the perforations may be randomly sized or deliberately sized with differences between perforations to achieve one or more objectives, such as the desired density of rawhide at certain locations within the pet treat. For example, it may be desirable to have a greater density of rawhide located at the ends of the pet treat with a lesser density rawhide located within the interior or middle portion of the pet treat. In this way, the structural integrity of the pet treat may last longer since it is known that an animal may first focus on chewing ends of the pet treat.

According to yet other preferred embodiments, the particular shape of the pet treat can be selected to target the type of play or interaction with an animal. For example in one embodiment, the pet treat may have a greater surface area and minimal thickness which may result in the animal more quickly consuming the pet treat. A pet treat having two layers configured in a substantially planar or a minimally curved shape may be representative of this embodiment. In another embodiment, the pet treat may have a reduced surface area with an increased thickness which will presumably result in the animal requiring more time to consume the pet treat. A pet treat having multiple layers configured in a rolled shape (such as a substantially cylindrical shape) is representative of this latter embodiment. In yet another embodiment, the pet treat may be comprised of multiple layers that are rolled together and then formed into a bone shape with two larger ends or sockets.

According to the preferred embodiments of the pet treat which include the paste-like or viscous filler material, it may be configured such that the viscous material partially fills, completely fills, or over-fills selected perforations. In this way, a desired ratio of filler material to rawhide may be achieved for selected portions of the pet treat. For example, it may be desirable to have the viscous filler material overflow selected perforations at one portion of the pet treat, while other portions of the pet treat have lesser amounts of the viscous filler material in which the filler material may only partially fill selected perforations. Specific examples of the viscous filler materials include, but are not limited to: rawhide and glycerin slurry, rawhide and gelatin slurry, vegetable and glycerin slurry, vegetable and gelatin slurry, protein meal and glycerin slurry, and protein meal and gelatin slurry. The viscous filler material may have a liquid or semi-liquid form at an elevated temperature during manufacture, and when later cooled, the material hardens. In the liquid or semi-liquid form, the viscous filler material is more easily incorporated within the base rawhide material, and further, selected amounts of the viscous filler material may be dispersed at desired locations within the perforations of the base layer.

Considering the above mentioned features of the invention, in one aspect, it may be considered a consumable pet treat comprising: (i) a base hide layer having a plurality of perforations formed therein; (ii) a filler layer positioned in contact with the base hide layer, said filler layer being made of a different material than said base hide layer; and (iii) said base hide layer and said filler layer being rolled together to form a final shape in which a cross-sectional portion of said pet treat includes a plurality of alternating layers of said base hide layer and said filler layer. In one embodiment, the filler layer is at least one of an extruded sheet-like material and a viscous material.

In another aspect of the invention, it may be considered a consumable pet treat comprising: (i) a base hide layer having a plurality of perforations formed therein; (ii) a first filler layer positioned in contact with the base hide layer, said first filler layer being made of a different material than said base hide layer; (iii) a second filler layer positioned in contact with the base layer, said second filler layer being made of a different material than said base hide layer and said first filler layer; (iv) said base hide layer and said first and second filler layers being rolled together to form a final shape in which a cross-sectional portion of said pet treat includes a plurality of alternating layers of said base hide layer and said first and second filler layers; and wherein one of said first and second filler layers includes a solid sheet-like material and the other of said first and second filler layers includes a viscous material that flows into selected perforations of said base hide layer. In one embodiment, each of the base hide layer, the first filler layer, and the second filler layer may have different sizes, shapes, or thicknesses. In another embodiment, the solid sheet-like material is an extruded piece of a consumable material.

In yet another aspect of the invention, it may be considered a method of entertaining an animal with a pet treat, said method comprising: (a) providing a consumable pet treat comprising: (i) a base hide layer having a plurality of perforations formed therein; (ii) a filler layer positioned in contact with the base hide layer, said filler layer being made of a different material than said base hide layer; and (iii) said base hide layer and said filler layer being rolled together to form a final shape in which a cross-sectional portion of said pet treat includes a plurality of alternating layers of said base hide layer and said filler layer; (b) providing the pet treat to an animal; and (c) allowing the animal to chew on the pet treat and to selectively ingest portions of the pet treat in which the perforations enable smaller pieces of the pet treat to be separated from the pet treat.

Other features and advantages of the invention will become apparent when reviewing the following drawings taken with the detailed description.

### BRIEF DESCRIPTION OF THE DRAWINGS

FIG. 1 is a perspective view of a base hide material used with one or more preferred embodiments;

FIG. 2 is a perspective view of a pet treat of the invention combined with a filler layer;

FIG. 3 is a perspective view of the pet treat of FIG. 2 and formed into a final or near final shape;

FIG. 4 is an end view of FIG. 3;

FIG. 5 is a perspective view of a bone shaped treat;

FIG. 6 is a perspective view of another embodiment including a base hide material and an applied viscous filler material;

FIG. 7 is a cross sectional view of the embodiment of FIG. 6 showing the viscous filler material filling perforations of the base hide material;

FIG. 8 is a perspective view of a pet treat in another embodiment of the invention including two base hide material layers and an extruded filler layer sandwiched between; and

FIG. 9 is a perspective view of a pet treat in yet another embodiment of the invention including a two base hide material layers and a viscous filler layer sandwiched between.

### DETAILED DESCRIPTION OF THE DRAWINGS

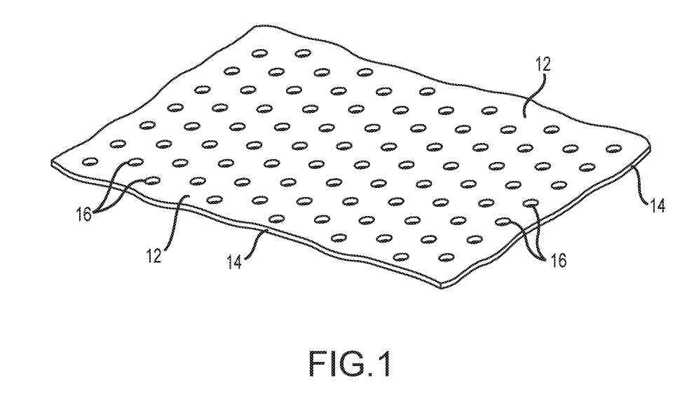

FIG. 1 illustrates a base material 12, such as a piece of rawhide that forms one primary component of the treat of the invention. The term “treat” as used herein is intended to cover any product that can be consumed by an animal, whether or not the treat may also be completely digestible. The term “hide” as used herein is intended to cover any type of animal skin, which may include, but is not limited to, rawhide, pig hide, and others. The piece of rawhide or base 12 is depicted as having a substantially uniform thickness 14 cut to a desired shape, with a plurality of openings or perforations 16. The perforations 16 are shown as having similar sizes and spread substantially uniformly across the base 12. However, it shall be understood that the perforations may be selectively shaped and selectively spaced from one another resulting in an irregular pattern of perforations on the base and/or perforations of different shapes and sizes.

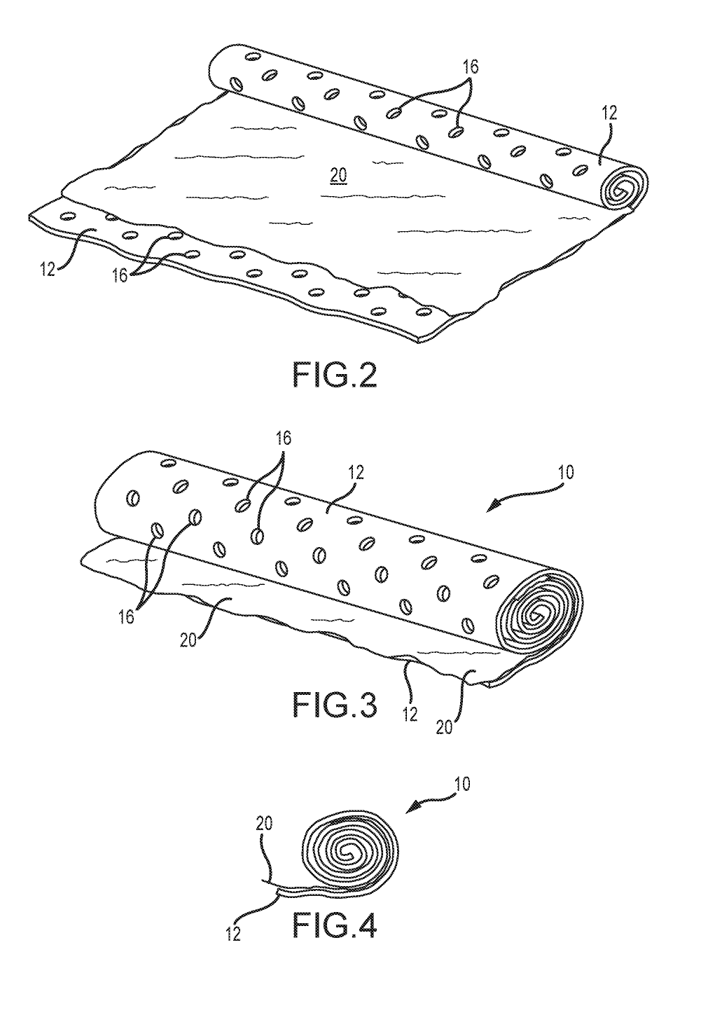

FIG. 2 illustrates the base 12 and a filler layer 20, such as an extruded piece of consumable material. The filler layer 20 could be another piece of rawhide, such as a sheet of rawhide formed in an extrusion process, or other types of materials such as extruded vegetable material, etc. In general, the filler layer 20 may be differentiated from the base 12 in that it is not perforated, and may have a different thickness, may be made of a different material, may be flavor enhanced to provide additional attraction to the animal, and/or may have a different color or texture. More specifically, FIG. 2 illustrates the filler layer 20 being partially rolled or held within the base 12.

Referring also to FIGS. 3 and 4, the pet treat 10 is illustrated in final or near final form in which the filler layer 20 is rolled within the base 12, with one portion or edge of the filler layer 20 remaining exposed as shown. According to the embodiment of FIGS. 3 and 4, a relatively dense and compact pet treat is provided in which the pet treat has a spiral configuration for the base 12 and filler layer 20, as best seen in the end view of FIG. 4. As an animal interacts with the pet treat, the animal can progressively bite and chew through the layers of material in which both the base and filler layer would be encountered. The perforations 16 allow enhanced workability for the pet treat; that is, the base is more easily rolled or folded as compared to if the base was simply a solid piece of material. Further, the perforations allow increased airflow or ventilation through the pet treat which may further enhance the life and integrity of the pet treat since moisture can be more easily evaporate from the pet treat. For example, animal saliva or exposure to the elements such as rain or snow may saturate a piece of rawhide material. To the extent that moisture evaporation was quite slow, this delayed evaporation can result in accelerated growth of bacteria or fungus on the treat which in turn, may shorten the effective life of the product. Additionally, the perforations 16 allow greater accessibility to the filler layer 20 since there is less surface area which separates the filler layer from the base. In this regard, a filler layer with an enhanced flavoring or texture may further intensify the desire of an animal to interact and chew on the pet treat. Another advantage of the perforations 16 is that they allow an animal to chew and separate smaller pieces from the pet treat, and the smaller separated pieces pose less risk to the animal with regards to a choking hazard or indigestion. Yet another advantage of the perforations is increased air flow through the pet treat for more efficient drying of the pet treat during the manufacturing process. The overall drying time is reduced and the consistency of the pet treat is enhanced as it relates to the overall final shape and size, as well as final moisture content when the pet treat 10 is ready for shipping. Particularly for rolled multi-layered rawhide pet treats of the invention, reducing the drying time and having greater consistency with respect to shape, size and moisture content provides for a better commercial product. Yet another advantage of the perforations is that the increased surface area afforded by the perforations therefore increases the amount of surface area in contact with digestive acids of the animal thus increasing digestibility of the hide material.

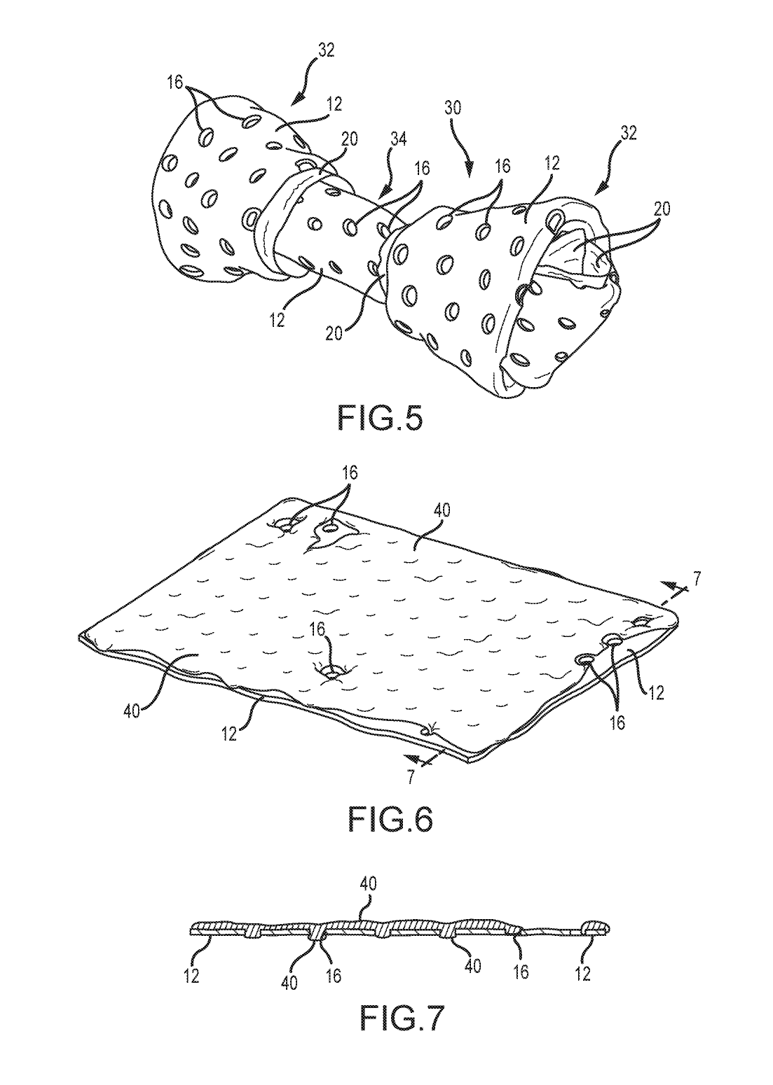

While FIGS. 3 and 4 illustrate a substantially cylindrical or rolled configuration for the pet treat 10, it is contemplated that the pet treat 10 can be provided in many other different shapes and configurations. For example, and referring to FIG. 5, in another preferred embodiment, a pet treat 30 is provided in the shape of a bone characterized by two ends or sockets 32 and an interior connecting portion 34. As illustrated in this figure, the filler layer 20 is incorporated within both the sockets 32 and the connecting portion 34 in which the base 12 covers the filler layer by wrapping the base material around and over the underlying filler layer. At least one edge of the filler layer may remain exposed for various purposes, to include aesthetics or to provide enhanced visual attraction to an animal. Because of the manner in which the base material is folded and wrapped, some of the perforations 16 allow direct communication with the underlying filler layer 20, while other portions of the treat only have wrapped or shaped portions of the base material.

Referring to FIG. 6, another embodiment is illustrated that includes another type of filler layer, namely, a viscous filler layer 40 that may be applied to the base layer 12 in a liquid or semi-liquid form (such as a paste). The viscous filler layer 40 is intended to be used with a wide array of options for providing the desired ratio between the layer 40 and the base layer 12, as well as to provide a desired amount of penetration of the viscous layer into the perforations 16. In one example, the layer 40 may fully fill selected perforations, while other selected perforations may have no or lesser amounts of the layer 40. The layer 40 may be added in a desired thickness between a rolled piece of the base layer 12, or may be positioned between pairs of base layers 12.

FIG. 7 shows an excess amount of the viscous filler layer 40 applied to the base layer 12. The excess filler material oozes or is squeezed beyond at least some of the perforations 16 on one side of the base layer 12 resulting in filler layer material residing on both opposite sides of the base layer 12. Depending upon the viscosity of the viscous filler layer, the amount of the filler material used, and the pressure applied to the filler material, selected amounts and locations for the filler material can be placed at desired locations within the pet treat.

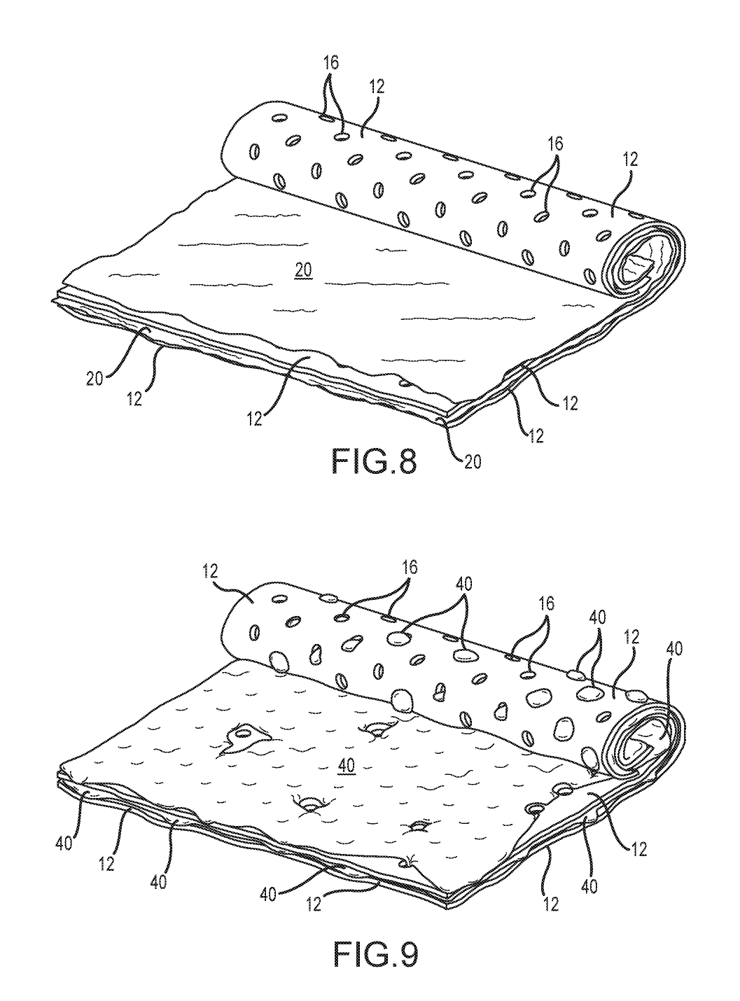

Referring to FIG. 8, yet another embodiment is illustrated in which two pieces or layers of the base rawhide material 12 are provided along with two filler layers 20. As can be seen in this embodiment, the addition of layers provides further options for adjusting the density of the pet treat and to provide further options for selecting a desired interior cross sectional composition of the pet treat. Optionally, each of the two pieces of rawhide material 12 may include perforations. Of course it will be appreciated that only one of the pieces of rawhide material may be perforated. In one embodiment, at least the exterior layer of the pet treat is perforated. Additionally or alternatively, one of the filler layers may be formed by an extrusion process and the other one of the filler layers may be formed of a viscous material the same as, or similar to, viscous filler layer 40.

Referring to FIG. 9, yet another embodiment is illustrated in which two pieces or layers of the base rawhide material 12 are provided along with two viscous filler layers 40. As shown in this embodiment, the addition of viscous filler layers provides yet further options for adjusting the density of the pet treat and to provide additional options for selecting a desired interior cross sectional composition of the pet treat. Each of the pieces of base rawhide material 12 may optionally be perforated.

While one filler layer is shown between the corresponding base layers for the embodiments of FIGS. 8 and 9, it is also contemplated that more than one filler layer may be disposed between the base layers, and further, that the filler layers may comprise combinations of both extruded type materials 20 and viscous filler materials 40.

According another embodiment of the invention, it may include two generally rectangular perforated sheets of base hide material with viscous paste placed between the two sheets. The layered pet treat is then pressed between two weighted, flat, metal screens (not shown) and then dried. Prior to drying, the weighted screens force some of the viscous paste through the perforations. Use of weighted screens during the drying process creates a consistently flat, planar pet chew treat when dried. It shall be understood that two perforated rawhide sheets of this embodiment can be cut into any desired shape, and additional sheets can be added with one or more additional layers of viscous paste between the additional sheet(s). Accordingly, the planar chew treat may comprise any number of sheets of the base hide material with at least some of the spaces between the sheets including some of the viscous paste. Additionally or alternatively, a filler layer of an extruded material may be included between one or more of the sheets of base hide material.

According to yet another embodiment of the invention, it may include two generally perforated sheets of base hide material with viscous paste placed between the two sheets, and the layered pet treat is again pressed and dried between two weighted, metal screens (not shown); however, the metal screens are undulated or curved. Prior to drying, the weighted screens again force some of the viscous paste through the perforations. This embodiment will therefore produce a wavy or selectively curved and non-planar pet chew treat when dried. As with the previous embodiment, the two perforated rawhide sheets of this embodiment can be cut into any desired shape, and additional sheets can be added with one or more additional layers of viscous paste between the additional sheet(s).

There are numerous advantages and benefits of the invention. A perforated base allows improved workability for hide material to be combined with various types of filler layers. For a solid sheet-like filler layer, such as an extruded filler layer, it may be conveniently placed in one or more layers between selected layer(s) of base material. For a viscous filler layer, the perforated base layer is ideal for adapting wide variations of amounts of the viscous material to be used for various purposes. The viscous filler layer can be used to adjust a desired density of a ratio of base material and filler material, in which the viscous filler layer is able to migrate into selected perforations and in selected amounts based upon the amount of filler material applied, the size of the perforations, and the distribution perforations. Further, the viscous filler layer can be used as a binding or holding agent to maintain the pet treat in a desired shape. Further, the perforations allow separation of smaller pieces of the pet treat to minimize a choking hazard or indigestion.

The invention is disclosed in one or more preferred embodiments. However, it shall be understood that various changes and modifications can be made to the invention commensurate with the scope of the claims appended hereto.

What is claimed is:

1. A consumable pet treat comprising:
a base hide layer having a plurality of perforations formed therein;
a filler layer positioned in contact with the base hide layer, said filler layer being made of a different material than said base hide layer; and
said base hide layer and said filler layer being rolled together to form a final shape in which a cross-sectional portion of said pet treat includes a plurality of alternating layers of said base hide layer and said filler layer.

2. A pet treat, as claimed in claim 1, wherein:
said perforations are substantially equally spaced from one another across said base hide layer.

3. A pet treat, as claimed in claim 1, wherein:
said perforations are of substantially equal sizes and shapes.

4. A pet treat, as claimed in claim 1, wherein:
said perforations are of substantially different sizes and shapes.

5. A pet treat, as claimed in claim 1, wherein:
said filler layer is a solid sheet-like material.

6. A pet treat, as claimed in claim 5, wherein:
said filler layer is made from an extrusion process.

7. A pet treat, as claimed in claim 1, wherein:
said filler layer is a viscous material that flows into selected perforations of said base hide layer.

8. A pet treat, as claimed in claim 7, wherein:
said viscous material of said filler layer comprises one of: rawhide and glycerin slurry; rawhide and gelatin slurry; vegetable and glycerin slurry; vegetable and gelatin slurry; protein meal and glycerin slurry; and protein meal and gelatin slurry.

9. A pet treat, as claimed in claim 1, further comprising:
a second base hide layer, wherein said filler layer is positioned at least partially between said second base hide layer and said base hide layer.

10. A consumable pet treat comprising:
a base hide layer having a plurality of perforations formed therein;
a first filler layer positioned in contact with the base hide layer, said first filler layer being made of a different material than said base hide layer;
a second filler layer positioned in contact with the base hide layer, said second filler layer being made of a different material than said base hide layer and said first filler layer;
said base hide layer and said first and second filler layers being rolled together to form a final shape in which a cross-sectional portion of said pet treat includes a plurality of alternating layers of said base hide layer and said first and second filler layers; and
wherein one of said first and second filler layers includes a solid sheet-like material and the other of said first and second filler layers includes a viscous material that flows into selected perforations of said base hide layer.

11. A pet treat, as claimed in claim 10, wherein:
said perforations are substantially equally spaced from one another across said base hide layer.

12. A pet treat, as claimed in claim 10, wherein:
said perforations are of substantially equal sizes and shapes.

13. A pet treat, as claimed in claim 10, wherein:
at least one of said perforations is of a substantially different size or shape.

14. A method of entertaining an animal with a pet treat, said method comprising:
providing a consumable pet treat comprising: (i) a base hide layer having a plurality of perforations formed therein; (ii) a filler layer positioned in contact with the base hide layer, said filler layer being made of a different material than said base hide layer; and
said base hide layer and said filler layer are formed in a final shape in which a cross-sectional portion of said pet treat includes a plurality of alternating layers of said base hide layer and said filler layer;
providing the pet treat to an animal; and
allowing the animal to chew on the pet treat and to selectively ingest portions of the pet treat in which the perforations enable smaller pieces of the pet treat to be separated from the pet treat.

15. A method, as claimed in claim 14, wherein:
said perforations are substantially equally spaced from one another across said base hide layer.

16. A method, as claimed in claim 14, wherein:
said perforations are of substantially equal sizes and shapes.

17. A method, as claimed in claim 14, wherein:
said perforations are of substantially different sizes and shapes.

18. A method, as claimed in claim 14, wherein:
said filler layer is a solid sheet-like material.

19. A method, as claimed in claim 18, wherein:
said filler layer is made from an extrusion process.

20. A method, as claimed in claim 14, wherein:
said filler layer is a viscous material that flows into selected perforations of said base hide layer.

21. A method, as claimed in claim 14, wherein:
said base hide layer and said filler layer are rolled together to form a final shape.

22. A method, as claimed in claim 14, wherein:
said providing step further includes: (i) providing two perforated sheets of said base hide layer with said filler layer being a viscous paste and placed between the two sheets; (ii) pressing the two sheets with the viscous paste between two weighted metal screens so that some of the viscous paste is forced at least partially through the perforations; and (iii) drying the two sheets and viscous paste, wherein the pet treat dries with a final shape corresponding to an arranged shape of the two metal screens.

23. A method, as claimed in claim 22, wherein:
the two weighted metal screens are substantially planer and arranged substantially parallel to one another such that said final shape of said pet treat is substantially flat with planar exterior opposing sides.

24. A method, as claimed in claim 22, wherein:
the two weighted metal screens are wavy or curved such that said final shape of said pet treat is wavy or curved to match the corresponding arranged shape of the two metal screens.
